(19) United States
(12) Patent Application Publication
(10) Pub. No.: US 2015/0004581 A1
(43) Pub. Date: Jan. 1, 2015

(54) INTERACTIVE PHYSICAL THERAPY

(71) Applicant: Interactive Physical Therapy, LLC, Sylvania, OH (US)

(72) Inventors: David G. Selman, Adrian, MI (US); Paul A. Muneio, Sylvania, OH (US); Rhonda L. Winans, Blissfield, MI (US); Timothy R. Pryor, Sylvania, OH (US); Leonard O. Greninger, Sylvania, OH (US); Don R. Beeman, Waterville, OH (US)

(73) Assignee: Interactive Physical Therapy, LLC, Sylvania, OH (US)

(21) Appl. No.: 14/350,604

(22) PCT Filed: Oct. 17, 2012
(86) PCT No.: PCT/US12/60484

§ 371 Date: Apr. 9, 2014

Related U.S. Application Data
(60) Provisional application No. 61/547,792, filed on Oct. 17, 2011.

(51) Int. Cl. G09B 19/00

(52) U.S. Cl. CPC G09B 19/003
USPC 434/257

(57) ABSTRACT

Persons recovering from injuries or surgeries today generally undertake physical therapy to regain usage of their muscles, joints and other portions of their body. Unfortunately such treatments often do not fully restore the patient's function, at least within constraints of the funds available. Added costs are also incurred by patients for transportation, time off work and the like. Disclosed are systems and methods to provide greatly improved and much more cost effective physical therapy regimens utilizing an interactive approach which makes possible physical therapy at home in a controlled manner. The physical therapist using the system instructs the patient and this instruction is incorporated into an intelligent camera-based system usable by the patient in the home or workplace. Dialog may take place between the patient and therapist using the system and the internet. Other features of the system increase motivation of the patient to perform the exercises prescribed.

### CROSS REFERENCE TO RELATED APPLICATIONS

The present application is related to the following pending applications of one of the inventors, Timothy R. Pryor, the disclosures of which are incorporated by reference.
U.S. application Ser. No. 12/358,404, entitled “Motivation and Enhancement of Physical and Mental Exercise, Rehabilitation and Health.”
U.S. application Ser. No. 12/754,285, entitled “Camera Based Interactive Exercise.”
U.S. application Ser. No. 12/941,304, entitled “Motion Based Video Games,” now U.S. Pat. No. 8,068,095.
U.S. application Ser. No. 13/544,180, entitled “Improvement of Mental Health and Well-Being.”

### FIELD OF THE INVENTION

The present invention relates to physical therapy and equipment therefore, generally using at least in part, one or more electro-optical sensors such as a TV camera to determine motion and position of a patient to aid in a therapy program to recover from injuries or surgical procedures.

### BACKGROUND OF THE INVENTION

There are rapidly growing needs for physical therapy. The following segments of the population typically require such therapy and continue to grow, in the U.S. and in all developed countries: the elderly, the obese and overweight, and persons of limited income. This in turn is a function of overextended health care systems, both private and government run, which simply can't support the amount of therapy it may take to return a person to “normal,” or even to basic functionality. In addition, today's society is very active, and with that activity injuries often occur that can require therapy. Where such persons are, for example, elderly or overweight, such therapy typically takes more time and thus cost.

The health care system operating under the traditional physical therapy model has many problems. Increasingly there is concern for the growing out-of-pocket expense which patients are less able to afford due to economic difficulties. In addition, the current system magnifies the impact of improper technique since patients don't have as frequent encounters for the feedback.

Compliance is also a major problem and a long standing one, also magnified by decreased frequency in visits per patient per diagnosis. Efficacy of physical therapy treatment is highly dependent upon patient compliance and only 34% to 62% of patients undergoing physical therapy correctly apply their exercise programs (Sluijs, et al., 1993).

Three main factors are related to noncompliance: barriers patients perceive and encounter; lack of positive feedback; degrees of helplessness. Resultant issues relating to the above are: a patient's decreasing visit frequency or withdrawal from therapy altogether; inability to get to high level of skill activity before discharge; perpetuation of improper exercise technique even after receiving home exercise instruction which results in lack of improvement; and an ongoing burden on the health care system.

Problems of the above have resulted in several responses by insurance companies, patients, and therapists, generally with negative health impacts. These include limiting visits, spreading visits out, and extensive use of home exercise in the traditional sense and often futile due to inadequate education and monitoring of the patients.

In view of the above, what is needed is a cost-effective device, system, method and software that may be: programmed by the therapist; personalized to the patient's therapeutic goals, to best practice standards; adapted for home use; adapted to provide oversight to the patient as the exercise(s) continue at home; adapted to provide real time feedback, captures therapeutic data, securely sends the data back to the therapist and/or doctor for review before the next office/clinic visit; adapted to provide motivation to the patient to do the prescribed regimen; and adapted to accumulate data to allow improved therapy to be conducted in the future, both for the same patient and the population at large.

### SUMMARY OF THE INVENTION

The present invention overcomes in large measure the deficiencies of the traditional physical therapy model, resulting, we feel, in better outcomes at lower cost. It does so by providing simple, robust and affordable methods for instructing, motivating, monitoring and evaluating persons undertaking physical therapy.

In one embodiment, a device includes one or more 2-D or 3-D cameras to obtain data from various portions of a person (hereafter referred to as a patient) or of an object used by the patient in performing manipulations prescribed of a physical therapist (hereinafter referred to as a therapeutic movement or exercise). This data relates to positions, orientations and movements of these portions and where desired, can further be combined with additional sensed data provided by sensors of pulse rate, blood pressure, blood oxygen, EKG or other. In some embodiments the camera(s) are included in portable devices such as smart phones or tablets which have integral display, computation and communication capability. Such devices may also optionally allow input of voice information and commands by a patient or therapist. In effect, the device augments the physical therapists.

The proposed solution is a less expensive alternative to traditional therapy and provides improved quality of exercise experience as a result of real-time custom feedback through the appliance. In addition, it provides improved compliance and further facilitates independence and self-responsibility for achieving the patient goals. And it facilitates advancement as mastery of exercise increases (ROM, Strength, Endurance, Proprioception, Power, Return to or exceed normal).

The device can allow multi-dimensional visual and audio demonstration as opposed to two-dimensional passive piece of paper. In addition, the device continues to emphasize the role of the individual therapist in customized care of the patient, who is not only able to interact with the therapist (in person via a communication link or with a computer stored image and/or voice) but to add music and “gaming” to facilitate competition.

In summation, it is a goal of the present invention to provide improved methods of home treatment and providing information for physical therapists to indicate movement in a given angle or dimension, the number of repetitions and rate achieved by a patient, and the progress made while further motivating and informing the patient.

It is also a goal of the present invention to provide a method and apparatus by which a physical therapist may teach a computer based system the exercise for a patient and then have the system monitor the patient based on that teaching while also gathering data on the created exercise, and where desired, motivating the patient to perform the exercise and to perform it properly.

It is also goal of the present invention to provide low cost computer and electro-optical means for determining positions and movements of persons and machines at multiple points at rates sufficient to accurately determine the information desired, and to do so in 2D or 3D as needed using simple affordable equipment.

It is a further goal of the present invention to display needed information, goals, historical data and other information of use to a therapist or patient.

It is a further goal of the present invention to improve compliance of patients with prescribed treatment plans.

It is also a goal of the present invention to provide method and apparatus to enable persons to undertake exercise therapy activity with reduced risk of overexertion or strain.

It is a further goal of the present invention to provide means for patients to enter pain indications into a therapy program, relating this data to data such as position at which the pain occurred, velocity, number of repetitions and the like.

It is also a goal of the present invention to provide a means to play entertaining games which further may provide motivation for performing the desired physical therapy exercises.

It is an additional goal of the present invention to provide methods to assist in the treatment of injured persons wherein a form of companionship may be provided the user, as well as a link both to others with similar injuries or to therapists.

It is a goal of the present invention to provide a method for setting guidelines and alarms relative to patients' positions, orientations or movements for physical therapy related activity.

It is a further goal of the present invention to assist a user to optimize their performance of exercise or other activity using data feedback from points determined by the device, as well as optional information obtained from other sensors such as heart rate, oxygen, acceleration, etc.

It is a further goal of the present invention to provide method and apparatus for data transmission over the internet to a physical therapy clinic or other health care facility, and to interactively suggest changes to the patient upon analysis of the data sent.

It is also a goal to provide sensing methods suitable for physical therapy which use simplified machine vision processing means operating on normal RGB type color cameras, such as webcams.

It is a further goal of the present invention to provide methods for calibrating systems with respect to the sensor and display device and to provide simplified methods of setting up the system in different locales.

It is another goal of the present invention to measure the positions or orientation of a portion of a patient and from that instructs the patient where to position or orient the portion in order to properly conduct the exercise desired.

It is a goal to aid patients in performing Codman's exercise or other exercises for rotation cuff repair, for knee therapy exercise, and for other isolated movements, especially for patients with acute and sub-acute problems.

It is a further goal of the present invention to provide an easy to teach system to allow the therapist to tailor exercises to specific patients and to monitor the patient's progress, building a database for future reference where desired.

It is a goal of the present invention to gather data which may be used to construct one or more databases for a given therapy which may be used to establish a best practices norm.

Further features and advantages of the present invention will be set forth in, or apparent from, the detailed description of embodiments of the present invention which follows.

### BRIEF DESCRIPTION OF THE DRAWINGS

FIG. 1 illustrates instructions for patients typical of instruction sheets used today for certain arm and shoulder exercises to be done at home as part of a therapy plan.

FIG. 2A illustrates an arm exercise during an educational session with a physical therapist according to an embodiment of the present invention, further illustrating a display to the patient of the arm including limits set by the physical therapist.

FIG. 2B illustrates camera data relating to the patient's arm positions and movement thereof in performing an exercise.

FIG. 3 illustrates procedures followed by the patient at home beginning the therapy regimen, including system calibration and communication both voice and data with the therapist.

FIG. 4A illustrates a standing shoulder exercise performed with the aid of an embodiment of the present invention.

FIG. 4B illustrates the image transmitted from the camera of FIG. 4A and the application of bounding boxes to aid in setting exercise parameters by the therapist, which may also be displayed on a monitor provided for the patient.

FIG. 4C illustrates a Microsoft Kinect sensor controlled by a PC and having an added IR LED and an optional camera to sense retro-reflective target data or other data.

FIG. 5A illustrates an exercise according to the present invention including a simple game and further illustrating measurement of x, y and z location of points on a resistance band stretched and moved by the patient.

FIG. 5B illustrates the image of a ball attached to the resistance band of FIG. 5A before and after extension of the resistance band by the patient, which effort locates the ball closer to the camera and in a different xy position with respect to the camera image plane.

FIG. 5C illustrates a table of values for taught and test positions of a movement in up to 3 axes.

FIG. 6 illustrates a social interaction activity undertaken as part of therapy, further illustrating processing of data at a central facility.

FIG. 7 illustrates teaching of the patient to position and orient their arm or other body portion based on the therapy program determined.

FIG. 8 is a flow chart of physical therapy as practiced today.

FIG. 9 is a flow chart of a physical therapy method in accordance with an embodiment of the present invention.

FIG. 10A illustrates a lying down shoulder exercise monitored in accordance with an embodiment of the present invention.

FIG. 10B illustrates a motion sequence of data points in one Cartesian axis taken as a function of time for a particular patient.

### DESCRIPTION OF THE CURRENT EMBODIMENTS

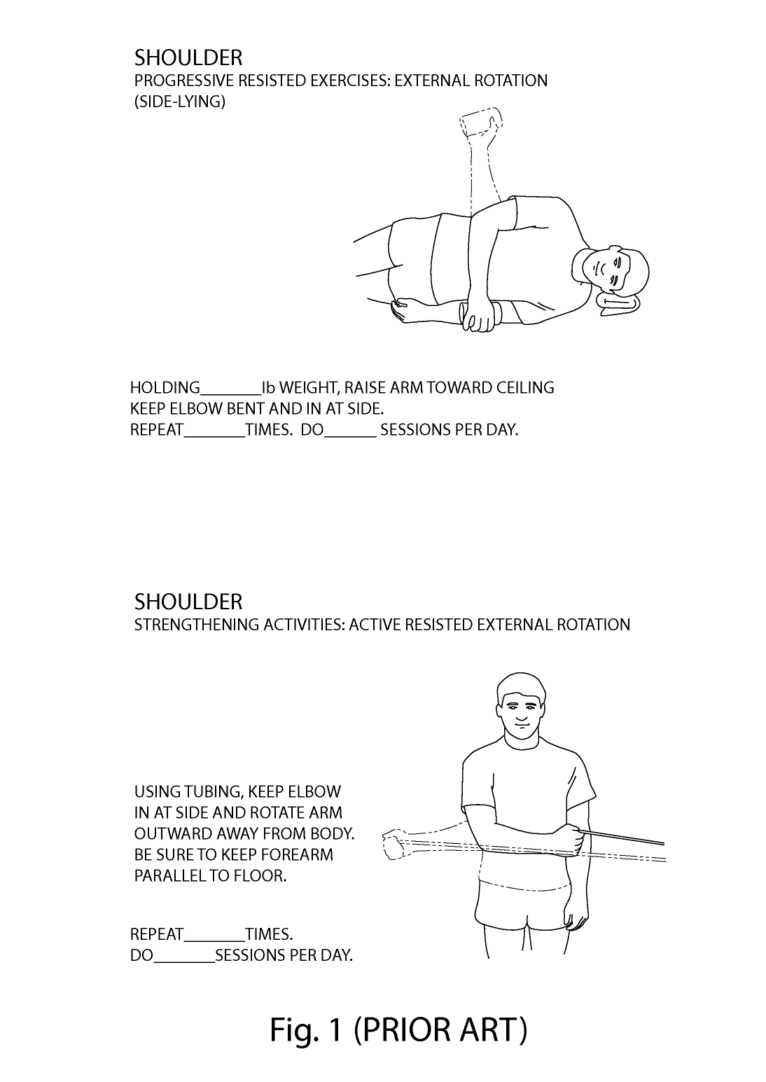

### FIG. 1

Steps undertaken in typical practice today are typically, but not necessarily, as follows. First the patient is referred by a doctor to therapy clinic as a result of orthopedic surgery or some injury. After consultation the physical therapist then makes an initial treatment plan, and typically may then be instructed on some useful manipulation of the injured member(s) to do at home. The patient comes back after a few days and has another session with the physical therapist. The patient returns, and the process repeats for several more sessions. The patient is finally finished with treatment, however often this is before being returned to normal (pre-operation or pre-injury) generally because funds run out or some other reason.

Shown in FIG. 1 is a typical instructions sheet provided to patients by physical therapists today, generally in sheet form for exercise to be done at home as part of a therapy program or regimen. At the physical therapy clinic once the client (patient) has been diagnosed, the physical therapist typically chooses one or more standard exercises from a selection stored on a computer, which may be a tablet computer. Sheets having these exercises are printed for the client, with instructions filed in. For example, as noted in FIG. 1, instructions may include the number of repetitions per set, the number of sets per day and the time holding ones position. The person is then sent home with the sheets, sometimes after an in-clinic practice session overseen by the therapist or an assistant.

These sheets try to be informative, but generally only show sketches of idealized persons. Beyond filing in the blanks, they are not custom tailored to the specific needs of the patient, nor reflective of more individual approaches of the therapist. Some are difficult to understand, and may not be clear where limits are as to maximum or minimum extension of various body portions. They provide no feedback to the patient or from the patient to the therapist, nor any opportunity for the therapist to comment on how the exercise at home is proceeding, at least until the next in clinic therapy session. Even then, the therapist has to take the patients word for what he or she did, which may be difficult for the patient to remember well. When the therapist looks at the patient's performance at the following session at the clinic (for example, in a few days time or a week), the therapist can often identify from the patient's demonstrated progress or lack thereof in the clinic, that the patient hasn't been doing them property or frequently enough. Often then the home regimen needs to be repeated until more progress is observed.

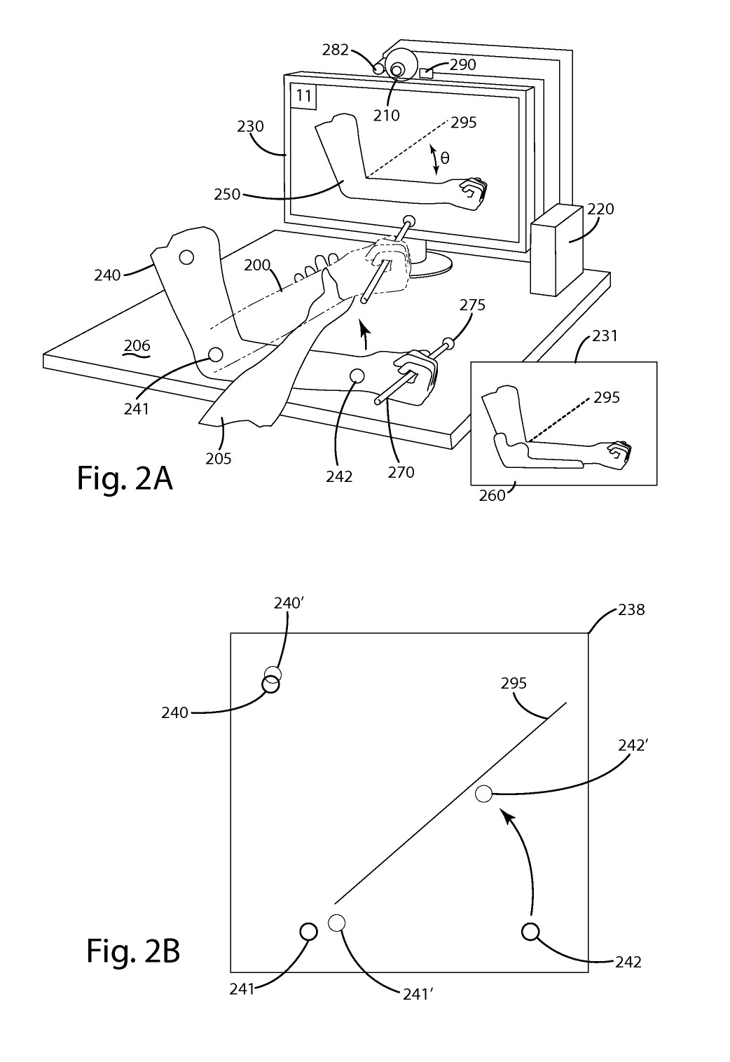

### FIG. 2

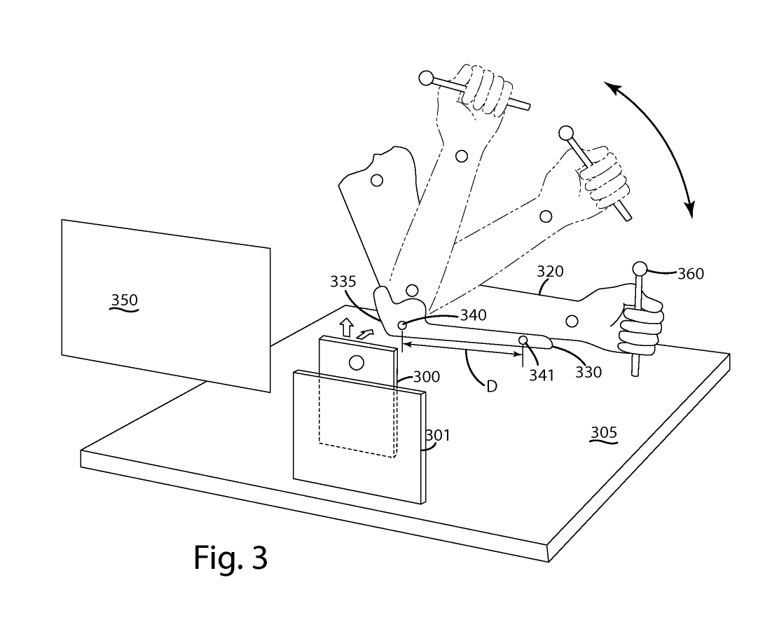

FIG. 2A illustrates a typical session in a clinic using the invention to aid in rehabilitation of a patients arm. The arm example will be used in FIGS. 2 and 3 for illustration purposes, although the device and method disclosed applies to almost all other physical therapy activity involving other body portions as well.

The physical therapist has first looked at the patient and through conversation, as well as analysis of medical records and the patient, determined the problem to be solved and the method of treatment including what sort of therapeutic movement or exercise would restore a muscle or other a portion of the body to health. In this session the physical therapist instructs the patient on how to perform a requisite movement exercise. Typically this is tried in the clinic, and after one or more further sessions, may be largely completed in the home in order to reduce cost and/or improve the number of sessions made possible within a cost budget in both travel time and clinical time.

To this point, the activity in the clinic is approximately the same with the disclosed device as it is today. However, the device proposes to add an additional step in the clinic whereby as a part of the teaching of the patient how to perform the exercise, which is typically done by moving the patient's arm in this case through the positions, orientations and motions needed by the therapist. The patient may, for example, move their own arm under guidance of the therapist or may be assisted in doing so by the therapist. During this teaching portion the camera system of the device is also taught, for example, the various positions undergone, the sequence thereof and the rates of motion desired. Other data can also be taught as well.

As shown, patient's arm 200 is being moved by a physical therapist, whose arm 205 is illustrated. Other portions of the patient and therapist are not shown for clarity. The arm 200 rests on a tabletop 206 and a digital camera 210 is connected to computer 220, such as a PC which controls a video display 230 used to display both video images of the teaching session, as well as to provide data to the therapist and ultimately to the patient at home using another display in the home or one carried from the clinic to the home.

In this example the therapist optionally also has a tablet computer 231 having its own display, and connected to the computer 220 so as to display the image seen by the patient, as well as other data the therapist may wish to consult.

In the case shown the motions of the arm are all in one plane. This plane of the arm may be at parallel to the camera image plane or located in an angle thereto. In the simple sensing example shown here, we will assume that it is parallel to the camera plane but if it isn't, a correction may be made as desired by knowing the angular relationship of the two planes, which can be derived by analysis of the data or some other calibration of target within the field of view of the camera that is related to the arm (see also below).

For the exercise in question, it is desired to keep the elbow fixed on the table top and move the forearm.

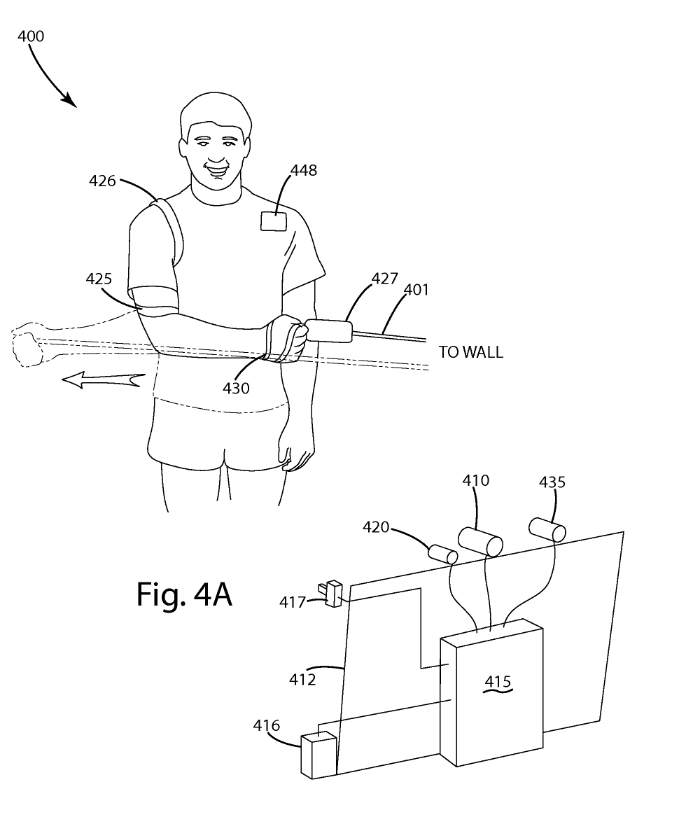

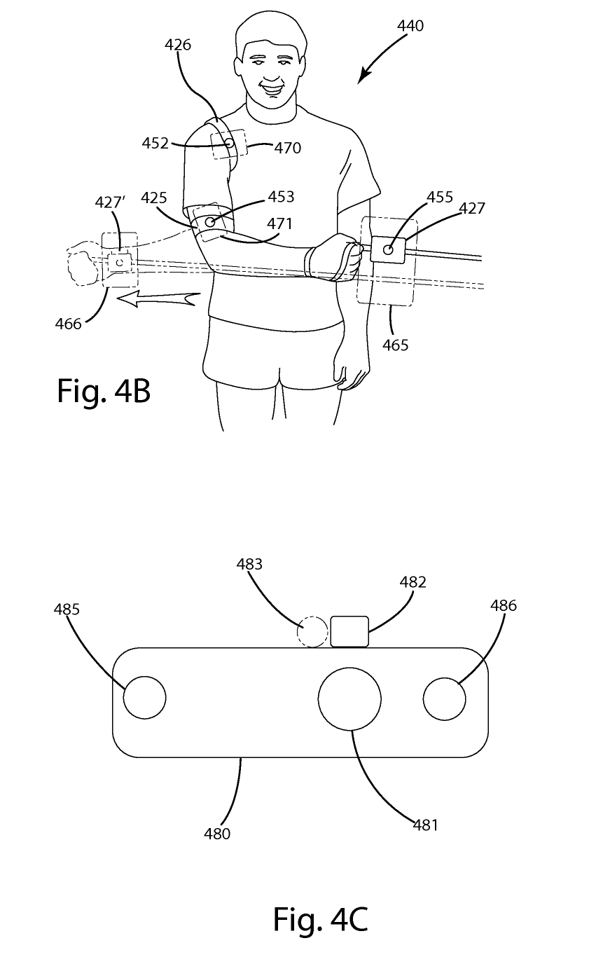

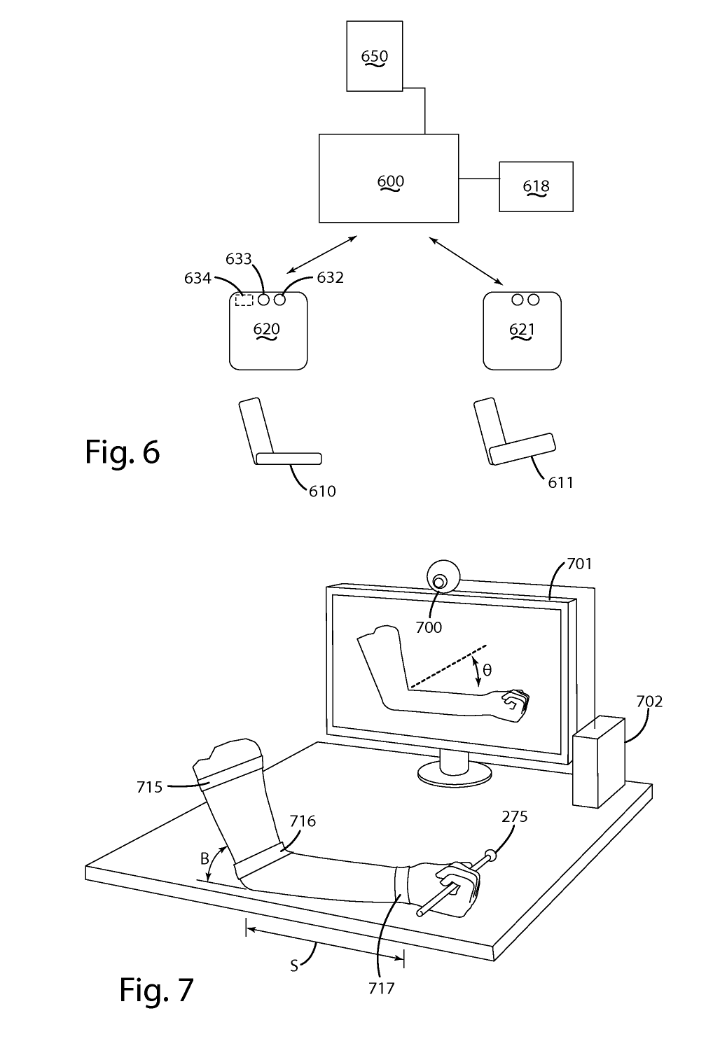

Now let us look at the therapist activity in teaching the desired arm motion. The camera records the movement of the body points, in this case on the arm. Target points 240 on the shoulder, 241 on the elbow, and 242 on the wrist that have been placed (or otherwise identified) on the arm of the user. Note too that for clarity the points are shown facing the reader, whereas they are in reality facing the camera to allow them to be seen thereby. These points can be attached by any convenient means, or alternatively may be on objects such as a resistance band, weight, weight bar, or ball used in the course of therapy. And they may be on an armband, bracelet or sleeve or other clothing-like object itself placed on the user, such as shown in FIGS. 4 and 7. Use of such targets simplifies the image processing of camera images, however alternatively with somewhat more complex image processing (for example, using edge operators such as Sobel transforms) and additional hardware in some cases, the actual image of the arm can be used without targets or with a lesser number of targets. Use of targets simplifies the discussion here, and the target images make convenient observation points for the therapist and patient during the training session, and subsequently by the patient in the home. Alternatively however, with suitable lighting such structured light and machine vision processing, one can sense the arm locations needed directly without the use of targets.

As the therapist moves the patient's arm up to an angle theta, the patient may for example, exhibit pain. Therefore for this first teaching session, the arm may not be moved as far as it ultimately should or could be, and a limit may be recorded into the computer program of the point reached by wrist point 242. In one example, the therapist uses the tablet computer 231 to record this limit data on the image 250, which is, in this example, the image on screen 230. Alternatively, screen 230 might be replaced by display screen 260 of the tablet computer 231 which could be shown by the therapist to the patient, including the process of marking or otherwise entering the limit (line 295 in this case, represented on the tablet and the large display 230). The computer 220 may optionally be replaced by that of the tablet 231 in some versions.

It is noted that range of motion may be larger for women than for men. This and other anatomical data may to be taken into account in setting limits for example too.

In some cases it is desired to see the orientation of the wrist since several different kinds of exercise can be done for different muscles in the arm depending on the wrist orientation with however the same movement of the arm through angle theta as just described. In this case and in one example of how to solve this, a weight bar 270 is gripped by the patient. This weight might be very small, perhaps even negligible in the first session, the point being here is to show that one or more points such as 275 at the end of the weight bar can be sensed by the camera as well and their relative positions in the image field of the camera provide the orientation data desired of the hand. Other image processing methods may alternatively be employed to determine hand orientation if desired in this exercise.

For example to illustrate in FIG. 2A, the wrist is open on the table and in other exercise positions and the monitored point 275 is in the plane of the arm. For other exercises it may be desirable to work other muscles of the arm. For example the therapist may have the patient rotate his or her wrist such that the point 275 is now displaced away from the arm such as point 360 in FIG. 3, which displacement can be sensed so as to give that wrist orientation. The judicious use of images of common therapy objects (such as, for example, weight bars) in this manner allows data concerning key variables to be obtained with minimum sophistication and cost.

The movement of the points in the image field of the camera is read into the computer together with the timing of the movements and then stored in computer memory. During this time the patient is generally looking at the display watching his or her arm move and the associated target or other sensed points move as well. The image of these points is also obtained by the camera (or cameras). The stored point movement information then can be used to create, if desired, a stick figure model or 3-D model of the arm. This can be played back to the patient to show just what the motions are to be practiced at home or alternatively the patient's own arm image can be used and replayed to the patient with limits placed around the points or distances where it should go, such limits being essentially inserted by the therapist as a percentage of the movement or the maximum angular deviation of the fore arm or some other criteria.

It is important for many exercises to fix certain points of the patient's body. It has been discussed above that keeping the elbow fixed on the table by the patent is useful in some arm exercises. One also would like to say that the shoulder point is substantially fixed as well to the extent the patient can keep it that way. It should be noted, however, that unwanted movement in this case of the desirably fixed points such as 240 and 241 in this case, can also be monitored by the camera and compared to allowable norms for same in the computer. If the movement becomes too much, an audio or visual message for example can be played to the patient that they've got to do some fixing or other adjustment. In some cases the movement can be determined and used to alter other variables, such as a display of the angle theta the person should try and achieve.

Such problems are also logged into the computer for future analysis by the therapist or possible transmission is discussed below to the therapist. Another example of such logging would be if pain was felt in performing the movement. For example it could be that on the 11th repetition at some point within the movement path a pain is felt by the patient. This the patient can speak into the microphone 290 interfaced to the computer 230 and this data can be logged or transmitted as well which even when combined with camera data approximately tells at what point in the exercise path the pain started. This data (as well as other data which may be logged into the computer) may be used by the therapist to analyze what is going on and may be further used to possibly to alter the regimen.

It is noted that the therapist can enter various other data on the tablet clinically relating to the patient, or instructions to the patient, which can be video as well. Indeed a video of the teaching session herein can be stored and transposed as required to a computing device used by the patient at home.

Also shown on the display is the number of the instant repetition (e.g. 11 in the case shown here, depicted in the upper left corner of screen 230) and the number of repetitions left to go if desired for this session. Such limits may be reprogrammed as therapy proceeds, or modified due to problems such as pain experienced by the patient.

It is noted that the display 230 if desired may be placed in another location, for example directly ahead of the patient, in order to facilitate viewing by the patient. In this case the camera would be mounted to a stand or any other convenient means. In some cases it can be desirable to use more than one camera to gain different views of the patient, though this is more difficult to set up, especially in the home. Stereo camera pairs may be used to give accurate three dimensional views of the patient from one location, assuming a sufficient base line between the cameras (see for example the Tablet PCs of FIG. 6).

Returning now to the teaching of a patient at the therapy clinic, FIG. 2B illustrates analysis of camera data relating to the patients arm positions and movement thereof. In this figure (which corresponds to the image of data points on the camera chip 238, when all other background and arm information is removed) we see that the three points in question at a first rest motion on the table are shown in solid dots 240, 241, and 242, representing the points on the shoulder, elbow and wrist (or alternatively a hand or object in the hand such as a weight) respectively. As the forearm is moved upward they are in position represented by open dots 240′, 241′, and 242′, respectively, with the wrist approaching a desired angular limit line 295 which the therapist has prescribed for the movement. As shown in this example, the shoulder has been sensed to have moved hardly at all (as 240 and 240′ are close together), but the elbow has moved a bit up and to the right. This movement, if too much, needs to be corrected and the exercise repeated with the elbow fixed as possible. If within some small range the elbow change in position can be computer corrected to adjust for the answer ascribed to the wrist movement. The wrist as desired has moved up to near the angular limit 295 specified by the therapist as the target for the exercises in question.

An angular limit line 295 is placed by the therapist using a computer input either graphically using a touch screen or in any other practical means, for example, by drawing on the screen a line indicating where the ultimate limit for the set of exercises should lie. This limit can be changed over the internet, if desired as the patient improves or upon the next visit of the patient to the clinic. This information to can be changed in order to improve the patient's performance or possibly to back off the exercise in case of pain or other problems.

Similarly limits can be placed on the speed of repetition, in other words how fast a person should perform this exercise, which can be determined by analyzing the camera output and information provided on the screen or audibly via a speaker not shown (such speakers are present in many smart phones and tablets which may be used).

It should be noted that one can to a degree solve and correct in the computer any miss-positions of a body portion such as an elbow, or the shoulder. For example, if the patient every so often or even most of the time can only perform this exercise by making a slight movement of the shoulder or slightly lifting off the elbow from the table as shown in this figure, one can solve in the computer what the effect of this is and correct the knowledge of how this exercise is going.

The display 230 may display a graphic display having the angular limits and other information. Alternatively, or in addition it may display the actual camera image 250 of the patients arm including an upper angular position limit 295 set by the physical therapist.

Further illustrated is a series of successive arm datum positions taught by the physical therapist to the patient who are sensed by the camera and stored into the computer. Note that the shoulder has been detected as moving slightly and noted.

A table of values of the movement of points as the therapist assists the patient to move their arm may be generated, with xy values (of say point b in this simple arm rotation example) as a function of time. As one example, the patient can be instructed to maintain the velocity of motion so determined as well as the number of repetitions and repetitions per minute, if so desired.

As noted above, using more sophisticated equipment capable of solving for the position in the arm from the raw image of the arm, it is not necessary to use specialized datum's or target markers. Such datum's however has an advantage that they make it easy to operate simple system in a normal environment using camera hardware such as a simple webcam. And such a camera as noted below can be included in other computer based objects such as phones, tablets, and other things in a very desirable manner.

The targets also give the therapist and the patient something to look at on the TV display or a transmitted TV image that is a clear indicator of movement and position. Target application can be simplified by having targets on things you put on such as a glove or bracelet. For another example a bracelet with many targets around its periphery could be used or a sleeve with multiple targets. There are many possibilities, all having some action of the user relating to using them, the action required varying considerably as to just what is required by the therapy in question.

One can use battery-powered LEDs as targets which are very visible but require battery power. Similarly retro-reflective targets generally have high contrast and generally provide easy discrimination against background objects, assuming one utilizes a LED such as 282 or other light source located near the camera axis to light up the target. Such an arrangement is provided in some cell phones, via the LED flash contained therein, which may operate in some cases in a continuous mode. Alternatively some data may be taken with flashed (stroboscopic) lighting, stopping the arm movement for the flash duration. Strobe lighting is also potentially useful with images of the arm itself, or of colored or white targets thereon. Many such target types have been discussed at length in the referenced co-pending applications.

### FIG. 3

FIG. 3 illustrates a set up procedure in the patient's home (or clinic) is now described which may be used for positioning the camera used (webcam, tablet, phone, etc) with respect to the arm.

As shown the smart phone 300 (e.g., an iPhone) is positioned on a stand 301 on top of table 305. The camera of the smartphone (typically but not necessarily the front facing one on the display side facing the patient in this example) views the patients arm 320 which is located, in this example, on rest 330 itself also located on table 305. The phone transmits via WiFi or the like, to a display 350 observed by the patient (and therapist if present).

The arm rest 330 has a rear feature 335 which serves to locate the patients elbow in the direction toward the patient, and thus in the xy plane perpendicular to the table. The rest has datums on it such as target points 340 and 341 which are at known separation distance D, and also parallel to the table. These points allow the camera of the phone to be calibrated, since the distance from camera to the arm rest 330, and position in the fore aft direction of the arm can be determined. If angulation in the vertical plane is a problem, one or more additional target points can be used to calculate that as well, such that correction of the camera data to that observed in the therapy clinic can be made.

Calibration points such as 340 and 341 on the holding device may also be used to calculate range of the camera with respect to the arm, and an attempt made to vary location such that range is set to substantially the same value as in the clinic or some other desired range, within at least an acceptable margin of error. This can alternatively be done by placing the phone at a range set with a meter stick for example.

When the patient has set up the device a test run is typically but not necessarily made to verify operation. Then the patient begins the exercise prescribed. The data is stored in the phone computer and may be transmitted as desired to the therapist at the clinic. In one exemplary mode of operation, this may be done in real time such that the therapist can converse with and instruct the patient at the same time. Where a display such as 350 is used or that of a device having one of reasonable size for viewing by the patient, the therapist may, via telecommunication to the display via the smart phone also to give a hands on demonstration of his own, showing the patient by example some aspect of the movement. The therapist has the benefit of seeing the patient make the moves with video from the smart phone camera, and/or seeing the movement of the monitored points, also as a function of time, as shown in FIG. 3b, including calculation of angles, positions, movements and other parameters.

Alternatively, or in addition, the camera can be used to sense points on the person and various angles and other relationships calculated with voice or graphical instructions provided to the patient. These instructions can be, for example, generated automatically by a program or by a person remotely who is observing the data.

Where targets are used, they may be found in the camera image by means of contrast, brightness, color, shape, and size for example, relative to their surroundings. While round dot type targets are shown in the case, other shapes such as squares, triangles and the like may also be used as disclosed in co-pending applications for example. As another example, groups of targets, such as 4 dots may also be used, allowing distance and angle to be determined from the target dot spacings. This has also been disclosed in co-pending applications. Use of dot type targets allows centroid calculation to be easily made to sub pixel resolutions as well. This is often desirable for maximum resolution using simple webcam devices.

The following is an example of performance information accumulated by the system (either locally or centrally as shown in FIG. 6) on a person performing the exercise.

Report

Patient: Jones, T

Set date: 19-9-2012

Start time: 11:01:58 End time: 11:02:17

Average/Baseline rep time: 3.0/3.1 s (−2%)

Pass rates

Proper/total repetitions: 0/4 (0%)

Static point Elbow: 4 (100%)

Static point Shoulder: 4 (100%)

Vector Extension: Start: 1 (25%) Max extension: 3 (75%) End: 0 (0%)

This data may for example be communicated by the smartphone (or other computer taking the data, for example over an internet connection) each night to the therapist who can keep up to date with the progress being made, and contact the patent for example if help is needed, or if the patient is not complying with the treatment plan.

An alternative performance table of a person performing the exercise could provide, for example, accumulated data over a period since the person was last at the clinic. If the images and sound are transmitted for solution to a central location as in FIG. 6, the data can be accumulated there and transmitted or otherwise provided to the therapist. In either case it may be desirable to provide this data to patients to show them how they are progressing. The data may be for example displayed on the display 350.

### FIG. 4

FIG. 4 illustrates a patient doing a standing shoulder exercise similar to the exercise shown in FIG. 1. The person 400 holds a resistance band (also called a theraband) 401 which is anchored to a wall or other suitable place, not shown. The patient is observed by a webcam 410 located on display 412 and is interfaced to computer 415 controlling the display and a loudspeaker 416 and a microphone 417 and other peripherals as desired. The camera has an IR band pass filter in place of the IR blocking filter normally provided with webcams, and senses near infrared light (one example having a wavelength of 830 nm) reflecting off the patient by IR LED illuminator 420, also connected to the computer 415. The goal of the exercise is to stretch the resistance band by rotating ones arm, keeping the upper arm close to one's side. The movement goes from the starting position (on the patients left side in the diagram) when the resistance band is just taut, to a point opposite on the patients right side as shown in dotted lines. However how far the patient can stretch the resistance band away from the wall is dependent on the patient's state of recovery and the force exerted by the resistance band (which comes in various types). The therapist observes the patient and the difficulty and seeks to set a limit on the movement range for the person's state of health at that time. The therapist also desires to set limits on permissible movements of the other body portions, since many times persons recovering from injuries are wont to move in manners that diminish the value of the exercise. An example here is that the person could make the resistance band stretch, not by rotating their rotator cuff as desired, but simply by turning their whole body.

In this example three targets are used, 425, 426 and 427, which in this case are retro-reflective to maximize signal received by the camera. Targets 425 and 426 are elastic arm bands with retro-reflective material such as 3M Scotch lite provided in a premade elastic arm, wrist or other band by Reflex Corporation. Target 425 is placed on the arm just above the elbow, and 426 is on the shoulder. The third target could be on the wrist such as 430, which can also indicate the range of motion, but is here shown as cylindrical retro-reflective target 427 on a cylindrical portion of the elastic resistance band itself near the gripping point of the person. Targets can often desirably be on objects providing resistance to human motion thereof, such as bands, weights and the like, as well as other objects associated with the exercise.

Additional information on the use of cameras to sense retro-reflective targets, and target designs can be found in the referenced co-pending applications. It should be noted that targets work quite well and the resulting images of target motion are easy for the patient and therapist to understand, a big advantage. Targets however do not have to be retroreflective, and with suitable care in machine vision processing, can be of any workable contrasting shade, pattern, or color which can be identified as the target in question.

FIG. 4B illustrates the image 440 transmitted from the camera 410 of FIG. 4A to the display 412 and the application of bounding boxes (or other visual indicia) to aid in setting exercise parameters by the therapist. As shown, the image utilized by the therapist may be that on the display 412 or on a separate display for the therapist (which could, for example, be a tablet screen as in FIG. 2A above) is of the patient doing the standing shoulder exercise. It is contemplated that it will be preferred to input information to the image directly, however information concerning the exercise may be typed in to a file, or communicated to the computer via voice recognition, or other means. Indeed a combination of inputs may be used for inputting information concerning the patient's exercise regimen. The image 440 can be the same one generated by the IR reflection sensing camera, in which case it is a monochrome IR image if filtered as described. However image 440 may if desired by created by a second color webcam such as 435 also interfaced to the computer 415, which provides a typical color image display for the therapist and/or the patient. Because the webcam 435 is not adjacent the LED illuminator, the retroreflective targets used in this example do not exhibit significant retroreflection and thus do not show as brightly as they otherwise would. If, however, diffuse white bands had alternatively been used, the resulting reflections would have been similar, all other things being equal.

In the image 440, the retroreflectors used 425, 426 and 427 show very brightly, with the persons image generally much dimmer. This is helpful for rapidly visualizing motion, or lack thereof. In addition, the computer 415 using a program written using and C++ and/or C# languages, and the OpenCV library can rapidly find the centroids of these targets in real time (e.g., at the camera 30 hz frame rate or greater). The calculated centroid such as 452, 453 and 455 may be for example displayed on display 412 or a separate display after processing by computer 415 as a red dot or other indication over the targets 425, 426 and 427 respectively. If desired the computer may also process out some of the bright target images so as to present a more uniform appearance of the patient and if desired further accentuate the centroid indications so they may be more easily seen, though this is generally not a problem. The target centroids, rather than the target images themselves, are generally used to set limits for target position and movement. Target parameters other than centroids may also be used, such as end points or the like, but centroids have an advantage that they do not vary if the image is out of focus, which can be the case, and in some cases is desirable, in order to provide more privacy.

Two alternative methods are now described for the therapist to program the system. In the first, the therapist after suitable explanation and demonstration to the patient may now ask him or her to perform the exercise and record the video images of several repetitions. In looking at these images, the therapist can chose one or more examples as good examples of that patient's performance at that point in their therapy. To assist in evaluation and aid the patient through interactive feedback, the therapist in one example places bounding boxes 465 and 466 around the starting and ending positions that should be reached by the patient in performing the exercise, given the patient's health at the time.

These points can be determined in one example by having the patient perform the exercise several times, and then observing the video data taken, stored in computer 415. One may if desired, throw out the badly done examples and keep the good, averaging the good examples to find a suitable start and end point which can be selected and a box placed around that point having some desired tolerance. The bigger the bounding box size, the more open the tolerance for example. For example the starting box 465 is quite large to allow the user to position the end of the resistance band in such a way as to take up slack. Conversely the box 471 around a point such as 453 that is not supposed to move side to side if the exercise is done properly, may be much smaller.

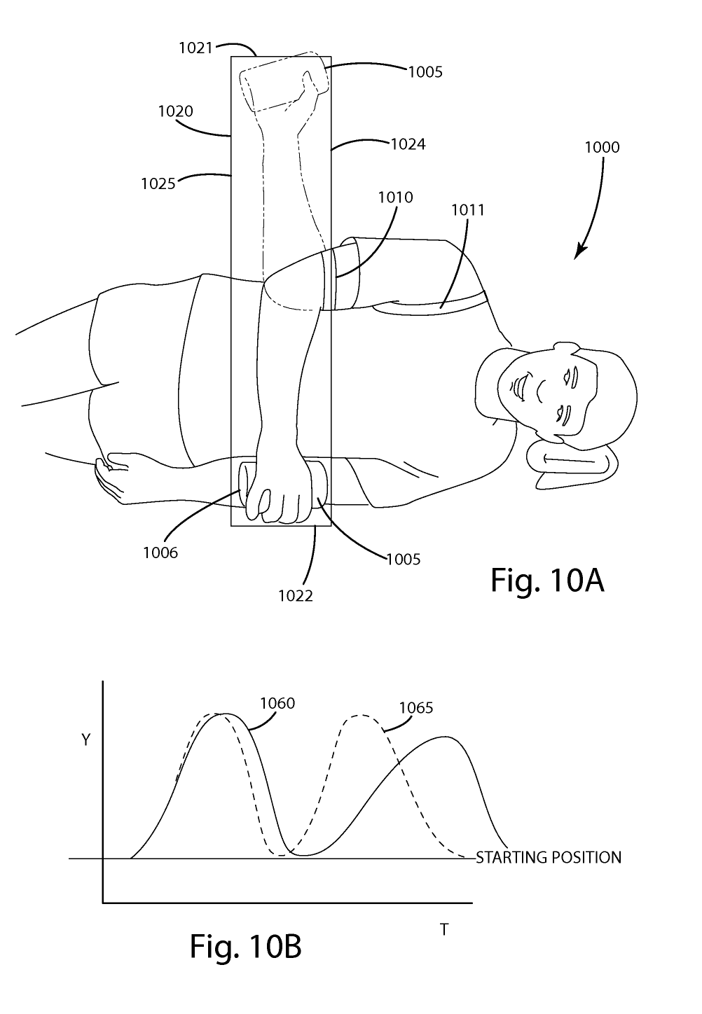

The starting point can alternatively be dynamically determined as the point at which the resistance band becomes taut. This can be determined by observation of the resistance band, which when taut takes the form of a straight line, which can be detected by the computer 415 in a camera image. Targets may be placed if needed on the resistance band to assist in recognizing this condition, and the resistance band color may be chosen to assist as well. By calculating the distance traveled from the just taut condition to the end point of the patient's motion in exercising the member in question, the force can, if desired, be determined for a known type of elastic resistance band. Using force data at various points, the work done in moving the resistance band can also be calculated. Other mechanical data can also be calculated as the positions are known as a function of time, since one can sense and store fifty or more data points just in one repetition (see also FIG. 10B). Similar calculations can be done for moving weights (including just the natural weight of the human themselves) against the force of gravity.

In a second mode example, the therapist instead moves the person's hands to a beginning point of the therapists choosing, draws the bounding box 465 there, which in the computer is referenced to a local position on the person such as a shoulder, a head, a center of area of the person or a portion, or the like. The setting of the bounding box alternatively can be done by looking at the display and voicing a command to box the target position at the point where the therapist gives the command, one that the patient has just reached for example. The therapist then moves the patient's arm back as far from the wall as he wants it to go to stretch the resistance band properly, and commands again to box that position with box 466. Similarly the therapist can ask the computer to find the other non-moving targets such as 425 and 426 in the image and box them.

Once set in the image, software in the computer can allow changes in box position or size by dragging or expanding the box on a touch screen for example. As noted above this touch screen could be of a separate iPad or other tablet computer connected to computer 415. Similarly if the patient can't move as far as expected, the therapist can drag the box to a position on the display requiring less force to reach.

The procedure just mentioned can be done quickly and does not require any knowledge of the exercise to be known a priori. Thus new exercises can be invented in this manner.

When the limits are set in this second mode, the therapist then asks the patient to try and do the exercise, as the patient sees it on the screen, putting his targeted grip 427 (or alternatively a wrist target) first in the image of the box displayed nearest the wall, and stretching the resistance band until target 427 reaches a position inside the bounding box farthest away from the wall. If the patient is unable to do this for the desired number of repetitions, then the bounding box locations can be moved or the size of the box opened up. Alternatively the number of repetitions called for can be reduced.

The therapist in addition may place bounding boxes such as 470 and 471 on two regions, the shoulder and elbow which are supposed to stay substantially fixed during the exercise. Different persons' elbows fall in different places (for example due to bulging chests and biceps), and it may not suffice to assume the elbow is vertically below the shoulder when against the side. As another example, the shoulder may be moved by the patient in trying to pull against the resistance band, which can be done by rotating the trunk without rotating the arm. This can negate the value of the exercise in trying to rehabilitate a rotator cuff problem. The purpose of monitoring these points is to provide an audible or visual signal the person (and the therapist as desired) so that they can correct the situation.

In a simple case, the corners of the bounding boxes are graphical representations of the x and y points corresponding to the CMOS or other camera chip coordinate locations of webcam 410. These chip locations may be desirably software corrected, if necessary, using means known in the art for any change in position or alignment of the patient from the originally taught positions. This correction is useful in any case, and generally required in the home, where the person is in a completely different location from the region where he or she was taught the exercise. One correction method is to look at the shoulder and use that as an origin point for the rest of the target positions. If before starting the exercise, the shoulder is in a new position xy, then the other box locations are adjusted accordingly such that the originally taught locations of the boxes remains referenced to the person.

In other words the machine vision program in the device of the invention desirably can find the person's location in the camera field, and then set the relation of the boxes to the person. This can be done by looking at the persons outline or other features, or by looking for example at the known targets used and setting up from there. Range cloud data can be used as well or alternatively.

The closer a bounding box is to the target image size in question, in general the more precise the person exercising needs to keep within the box in order to register a successful attempt. Typically the person can see a display and using that display attempt to reach or maintain the proper position within the box (while keeping other non-moving points near fixed as possible). In one example, if they have moved the target on the resistance band grip target 427 to be only half in the box 466 for example, the box color can be caused to turn yellow and an audible sound given. If the person on stretching the resistance band doesn't for example make it to the box at all, then in one example a repetition would not be registered and the person not given credit. In other examples, the actual ending point short of the mark could be recorded for later analysis by the therapist.

As noted, the targets can also serve to aid in locating the person in the field of view of the camera. It is also desirable to stage, where possible, the patients' exercise at approximately the same distance from the camera as in the clinic, though differences can be within limits compensated as well using computer 415.

To help with this set up, one can use a fixed target in the camera field as shown in the FIG. 3 as a calibration target. Alternatively, or in addition, one or more of the monitored targets on the person may be used. For example cylindrical target 427 on the round grip of the resistance band will look to be a cylinder of a certain diameter which increases as the camera gets closer to the target, and decreases as the camera is farther away. To aid this setup, an audible sound can be given to the patient when the diameter is sufficiently similar to that previous in the clinic. If the patient for example needs to be closer, and assuming the image of the patient can be satisfactorily seen in the field of view of the camera, one can use the increased diameter, to figure out compensation needed in various parameters, for example bounding box size and/or location. Other means to aid the patient in set up can also be performed, such as sensing range to the patient directly, and using that as a signal, or compensating parameters if the patient is within a working range.

It is noted that use of more complicated “3D cameras” (for example the triangulation type sold by Primesense, Microsoft's “Kinect”, or the time of flight version sold by Canesta) may be used at additional cost and complexity in place of a 2D camera such as the web cam 410. In this case measurements can in some cases be obtained from portions of persons without any special targets or objects. While seemingly desirable, today's cameras of this type are generally not accurate enough and/or reliable enough to be relied on for medical data such as needed for serious physical therapy pursuits. They may be in the future, though to be incorporated in portable consumer devices such as smart phones they also have to have minimal space and power requirements, as well as meet cost constraints.

The 3D data obtained with such cameras and particularly the range (z direction) data obtained can also be used to supplement the target data obtained, which when obtained with a single CMOS or other camera, are generally relating to components of movement in the xy direction in the plane of the camera chip. Besides or alternatively to the target data, range and/or outline data of the patient can be processed to assist the patient in setting up for the exercise, and for determining movements of body portions, including secondary regions that if moved or out of position may compromise the value of the exercise.

Range data can also aid the person to set up properly relative to the camera or in a more sophisticated case, to monitor such positions in such a way that errors in set up can be corrected in software, particularly for some exercises where relatively simple calculations suffice. Indeed this can be done with data taken by target means as well, if the amount of data is sufficient.

A combined sensor can be constructed using a Microsoft Kinect sensor as a base, a situation illustrated in FIG. 4C. In this example, a Microsoft Kinect sensor may be alternatively used to monitor a person undertaking the standing shoulder exercise, supplanting the webcam 410 of FIG. 4A. In this case the webcam 481 of the Kinect 480 may be used to take data from targets as before (using as shown a IR Led light source 482 added to the Kinect device), while the infrared triangulation based range sensing camera system (composed of projector 485 and camera 486 with IR band pass filter) is used to obtain numerous range points on the person which are analyzed by computer 415. Note that the added LED 482 can be a visible LED, IR having here been chosen (as was the IR Laser of the Kinect) to be unobtrusive to the patient. The range point data is processed by the PC 415 operating the Kinect to obtain an indication of twist in the torso of the person which is not generally desired in this exercise. The twist is determined by noting the change in range of region on the left shoulder and another region on the right shoulder. Range data from other patient regions can be monitored as well or alternatively if desired. If desired as well, the PC 415 may be used to calculate joint locations or other locations from “clouds” of range points, and these joint locations can often be helpful in aiding exercises such as those herein.

Note too that where desired, for example to separate range and target system function, a completely separate webcam such as 483 (dotted lines) similar to 410 can be used, rather than the webcam 481 of the Kinect.

For setting up, the patient in this example is instructed to turn so as to face the camera system, and range to the general region of each of the shoulders is monitored. When the range is substantially the same for the left and right shoulder measurement the patient is determined to be facing the camera and instructed to begin the exercise. In some exercises, it could be desired that the person face in another direction, say 20 degrees from the camera axis, this facing direction could be calculated from the range data and used to guide the person's setup if desired. And variances in orientation can be used to correct data taken, especially useful if for some reason the relative camera to person alignment cannot be set up in the home to achieve the original situation in the clinic. Alternatively if such problems were known, the clinic version could also be set up similarly to the home constraints.

Another machine vision approach is to use edge operators such as Sobel transforms to find the edges of the person or an object relating to the person. In some cases such data can be used instead of target data or in addition thereto. One can eliminate outliers (e.g., due to background conditions) and fit lines and curves to the data relatively easily since one has a knowledge of the person, and what portion of the person you are looking at.

It is noted that it may be desirable to monitor other points such as shoulders, trunks etc. on the patient as well as those discussed above, or in some cases alternatively. These too can be targeted, or alternatively monitored using other machine vision techniques to sense features or range points as disclosed above. It is noted that in some cases one may observe a monitored point in order to give an indication of some other condition taking place. For example if you monitor the rising up of your left foot in a knee exercise, it can indicate that you are improperly bending your right knee, simply because of the way the body itself is connected.

Steps undertaken to perform a typical exercise such as that of FIG. 4 in the home may be for example the following. In a first set up step, the patient places the camera of the system (whether separate or part of another device such as an iPhone) in a position to view the exercise, in this case with the camera axis approximately perpendicular to the plane of the patient facing the camera. The patient then fastens the resistance band to a door or wall and pulls it taut, positioning himself to begin the exercise. The computer using the camera image provides any desired instructions to the person to alter the set up. Alternatively such instructions can come via communications from a physical therapist remotely viewing the image or images stored in the computer.

The computer then displays on a display the image of the person and/or a target or targets used. Further displayed is the ending point or graphic (such as a bounding box, or circle say), where the person is to move. As the person moves, he may optionally see his progress on the screen toward the destination by a trail of dots until he gets to the destination. This knowledge of approaching and reaching the goal position can also or alternatively be communicated audibly.

The patient then begins the exercise and performs the required number of repetitions which are displayed or vocalized by the computer. If the goal graphic is missed, a display or sound can be provided. Similarly if a body portion such as a shoulder is moved unduly in performing the exercise, this is signaled to the user as well.

When the patient has satisfactorily performed the requisite set of exercises he is complimented and goes on to the next type of exercise, which may or may not require a different set-up. Meanwhile, if desired the data taken can be transmitted to the persons therapist at the clinic. Later in the day, or the week, the patient may be asked to repeat the exercise again. There is a possibility that by monitoring accurately what the patient is doing, that the therapist can suggest while the patient is at home, an improved therapy regimen that would allow the patient to get well sooner, with less visits to the clinic.

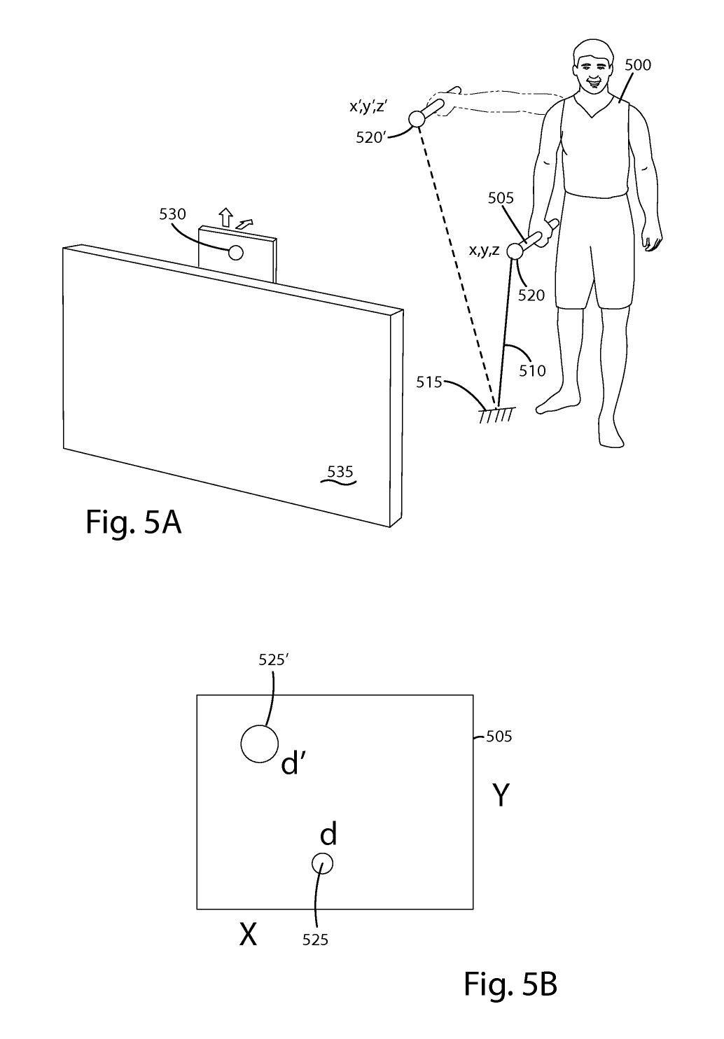

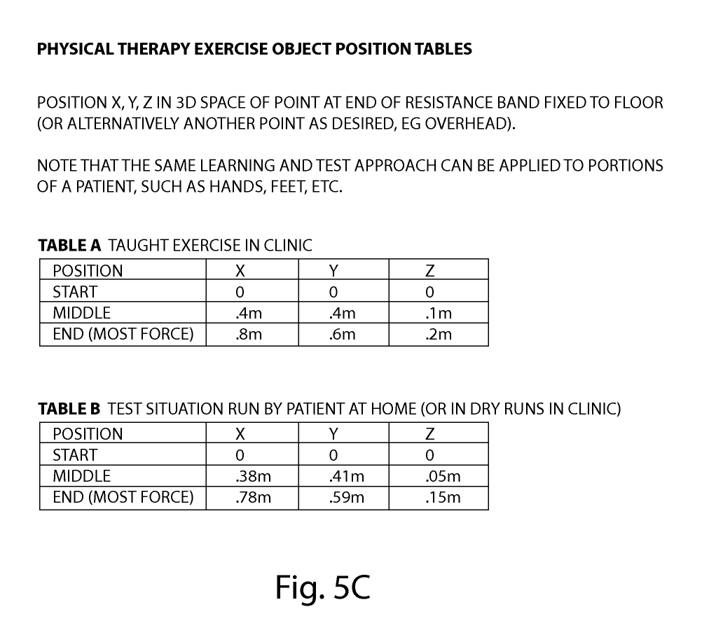

### FIG. 5

FIG. 5 illustrates another exercise according to the present invention including measurement of the x, y and z (range from camera) location of a point on a resistance band stretched and moved by the patient. As shown in FIG. 5A, a patient 500 holds a bar 505 attached to a resistance band 510 secured to the floor 515. The bar has a ball 520 of a known fixed diameter attached to it. As the patient lifts the bar with his arm as part of an exercise regimen, he moves it upward and further toward a camera 530 of a smart phone located in this case on top of an optional auxiliary display 535 facing the patient. The phone may be interfaced to the display via HDMI or other means to allow the camera image and other data to be displayed in larger more easily readable format than from the smart phone display itself (which of course, may be used as desired).

As an alternative to a smartphone, a tablet computer such as the iPad by Apple Inc. can be used. In this case the display of the tablet computer may be large enough to be comfortably viewed by the patient and thus obviate use of the still larger TV display if desired.

The new position 520′ of the ball 520 is determined in x and y by the camera and the computer of the smart phone which calculates in this case the centroid of the ball in the camera plane (here the xy plane of the camera CMOS imaging chip 505 shown in FIG. 5B). Additionally the area of the ball image, or alternatively its diameter (or other dimensions if not a ball target) is calculated. As shown, the diameter d of the ball image 525 has increased to that of 525′ due to the imaging by the lens of the smart phone camera, since the new position of the ball 520′ is closer to the camera than before. This new diameter d′ gives the new z location as a result of the ball movement. A calculation of the extension of the resistance band going from the original xyz value to the final xyz allows the force undergone in movement to be known if the co-efficient of elasticity of the resistance band is known or can be calibrated. In any case the movement is tracked by the camera and reported to the patient and/or stored as desired. And as before it can be transmitted to the therapist. Such transmission can be of the whole video image, or the image of the target points (with the rest of the image faint or non-existent) or the calculated target points only, or the data such as positions or movements of the targets only, or some desired combination. Before transmission it may be desired to scan the image in the smartphone computer and eliminate or render unrecognizable the facial features, or eliminate the head entirely from the transmitted imagery. Indeed there isn't a need to transmit the portions not related to the exercise.

An attractive transmission mode is to transmit a picture of the patient before commencing the exercise in order to assure proper setup for performing the exercise and with relation to the camera. From then on transmission may be of data only, which can be dynamically monitored by either the smartphone computer or a remote computing facility to see that acceptable movements and positions are being undergone.

Shown in FIG. 5C is a table of values created by the computer and camera of the device. Table A is a table created, in this case in the initial training by the therapist in use of the resistance device of FIG. 5A. As shown, the xyz locations of the ball are provided at the beginning, end and middle points of the extension of the resistance band. This first set of values shown in Table A is the reference taught by the therapist. A large number of additional intermediate points can also be gathered and stored if desired, creating a data stream that similar to FIG. 10B. There can be for example 50 intermediate data points if desired, assuming the camera and computer data rate can accurately track them, which it can in most cases for relatively slow movements (for example two seconds from rest to position theta in FIG. 2A).

At home, in one embodiment, the patient attempts to duplicate Table A done first at the clinic. In the home set up procedure, the camera data is corrected for any change in distance or angulations or other variable as present, in order that the instant data, in this case shown in Table B, can be compared knowledgeably with that of Table A.

It is noted that the rate of change of position can be determined as well by the computer based camera system, and this rate can be compared at different points in the motion with values suggested by the therapist. For example if the patient is going too fast, the speaker of the system can tell the patient to slow down and if desired a graphic shown illustrating the present and desired value to attain. Similarly if the positions being reached fall short for example of the desired stretching of the resistance band (and therefore force) in this example, the system can warn the patient, as well as logging in a possible error point. If there are too many patient errors for example, this can be communicated to the therapist to indicate problems with the program. The therapist can act on the data and contact the patient for example.

Tables with other data computed from the data taken, for example angles undergone, can also be kept.

The time variable, t, thus may also be logged in the Tables A and B, as well as other variables such as perceived exertion undergone or pain felt by the patient. As noted, heart rate, and other monitored variables using other equipment can be linked in the smartphone computer 530 (assuming a suitable data acquisition system, such as sensors whose data is transmitted for example by Bluetooth or other wireless techniques known in the art to the computer for example).

It is also noted that the data obtained may be used to predict how one should change the therapy based on the variables sensed to a certain point. For example, if a patient can reach a given range of motion or angular limit without pain after fewer repetitions than originally programmed, the therapist (or an automated program step) can instruct the patient to continue to another type of exercise, or to increase the angular limit or the rate of movement or any other desired function.

It should be noted the ball target 520 may be for example self-luminous to aid camera sensitivity in certain situations. For example a translucent ball the size of a ping pong ball may be lit up by one or more LEDs inside it. More simply one may just be an LED itself on the end of rod, fitted with a high divergence lens for example to aid viewing from a multitude of angles.

In addition the present invention comprehends that one might have more than one such ball or LED (or reflective target), attached in one example, to either end of a resistance band pulled apart using two arms of the patient (similar to a jump rope). Both balls in this case are observed by the camera, and their relative separation calculated to get a force related value due to elastic resistance band extension, in addition to their positions as desired.

The present invention further comprehends that one can have weights with reflective targets or light sources incorporated, and the weights can be independently moved with no connection between them. In addition, machines can have targets as well as pointed out in co-pending applications.

The device still further includes the possibility of targets whose shape or spacing may give orientation angles pitch yaw and roll as well as xyz, as desired. Co-pending applications have extensively discussed 3 and 4 dot target sets and triangles for this purpose, but others may be employed as desired.

Let us now recap one set of therapy steps that one might use with the new method represented by the present invention.

On the first visit to the clinic, the therapist does much the same as today, with the added step noted in FIGS. 3 and 4 of teaching both the computer system and the patient the exercises needed for the therapy prescribed. In some cases there can be many such exercises needed. In one exemplary application, the patient practices the exercises in the clinic under the guidance of the invention, thus freeing up the therapist to see other patients while still being able to monitor and understand how the patient is doing and thus correcting things that are wrong. For example, difficulties a patient is having can be sensed by the system and communicated via a text message to the therapist's cell phone, which can call up from the system complete data, video clips and the like.

Once the patient has an understanding of how to do the exercises needed for therapy and operate the system, the patient then goes home with the software (if they have the requisite hardware themselves) or hardware and software as the case may be, and begins the physical therapy regimen.

Desirably included with the software provided is additional training not only recapping the original session, including videos of the patient himself and the therapist doing the exercise(s) properly but also generalized training including for example 3-D graphical presentations or other of presentations that would be of the pedagogical value.

After a suitable time, the data taken from exercises being done at home can be transmitted to the clinic and analyzed by the therapist or others to see how it was progressing. The physical therapist can then discuss the results with the patient and suggest any corrections needed. Such suggestions might be needed very quickly if the data taken was completely in error, or it might be just require small changes be made in the regimen.

After the patient had the exercise under way the data would be then accumulated to the level of the desired number of repetitions and the limits and so forth. If all was going well the therapist then may re-contact the patient which could be done automatically in some cases. After consultation the therapist could reset by communication link for example the limits both as to the extension of the arm, number of repetitions, and the use of additional weight to be lifted by the arm in performing the exercise, and any other pertinent parameters.

Once again, the results of the new regimen may be analyzed by the therapist and further corrections made as needed. It could be that to this point no additional clinical visits would be required. However, at some point it would be desirable presumably for the patient to revisit the clinic go and go over all of the data and experience to date with the patient suggesting possible modifications or that therapist perhaps also prescribing a relatively changed way of doing the exercise, such as rotation of the wrist 90 degrees in the FIG. 2 example, in order to exercise another arm muscle.

This procedure proceeds until at some point the patient feels they were back to normal or some other criteria was reached. For those patients having multiple injuries they might proceed to another part of their body after finishing one part or another. A beauty of the device is that it may constantly refresh the patient as to just what they are doing and shows limits and graphics and online advice if needed to allow the patient to be able to perform the exercise correctly. This then allows one to switch from one exercise to another without becoming confused or by the same token, simply to pick up after a time period has elapsed, performing the same exercise and doing it correctly.

It should be noted that the PC computer 220 (or that of a smartphone or tablet or other computer as used) can be operated remotely by the therapist to allow helpful information to be displayed to the patient, or to allow additional camera data to be obtained where applicable. This can also be done when the patient first starts the device in the home, in order that they are assisted by a remote therapist in getting set up properly, concerning camera location where to stand, or the like. It is also noted that for some patients it may be necessary for a therapist's assistant to come to the home in order to help the person get started. If the system is to be left in place, the system can be adjusted and new bounding boxes placed for that particular set up if desired, essentially revisiting the teaching done in the clinic. When persons have several exercises to perform, such a refresh may be needed as it is hard to remember everything, even though video of the actual training session in the clinic can be replayed to the patient by the system.

### FIG. 6

Camera data of the patient's exercise can also be transmitted for processing remotely at the therapist location or another location. Such central processing of the data, for example from many patients, has several advantages. For example, it is generally agnostic to what device (smartphone, tablet computer, webcam, etc.) is acquiring the image data. In addition, the image data can be stored at the site, along with the processed data. And if stereo pairs of cameras (such as present even today in a few cell phones for taking stereo pictures for 3D television display are used), then the stereo pair data may be more efficiently processed by faster remote computers than on board the cell phone camera. Such stereo pairs, or even single camera, may be augmented by laser or other grid projectors to provide range cloud data as well, and this too can overload smartphone computing resources.

Generally the transmission and/or recording of image data should be secure in the sense that the person's privacy is respected. It may be desirable to transmit not whole video images but rather images of just the arm or other portion being observed for exercise monitoring purposes, or one can transmit just the position data determined by a local computer itself. Where high contrast targets are used, the position data can be effectively just that of the targets without the background of the room which is then filtered out using brightness, color or other means. Some faint image of the patient can be transmitted if desired to get a general feel for the movement, without seeing the patient themselves clearly. Alternatively or in addition, faces of patients can be blurred if desired using known software, particularly useful if recordings are to be made of the movements using video images.

As discussed above, it is desirable to create a game of the exercise in order to motivate the patient. Going one step further, it also possible to have multiplayer games in which patients may play together and against each other if the game and underlying exercise is suitable for same. Illustrated in this context is a social interaction activity undertaken as part of therapy, further illustrating processing of data by a computer 600 at a central facility in this case the therapy clinic, the computer 600 being electrically connected to a display 650 and computer readable memory 618. As shown two patients whose arms are 610 and 611 respectively are doing arm exercises in front of their systems, comprised by tablet computers 620 and 621 respectively. For clarity only the person's arms are shown. Each tablet is transmitting video information to the central computer 600 in this example, with little or no local processing at the patient site. Images of both patients (generally not just the arms) are shown on each other's tablet screens respectively. Each patient in this example is doing the same exercise, and they are trying to do it as properly as possible, with the computer giving each a score which is in one example, also visible by the other.

This can also as noted above further include 3D sensing with a portable device such as a smartphone having a stereo pair of cameras. In this example the smartphone may obtain images that can be used to determine 3D location of targets or other features. These images can be displayed to each of the players in a similar manner, on a 3D TV display.

For illustration tablet 620 is shown having a stereo pair of cameras 632 and 633, in addition to which it has an optional structured light grid projector 634 (dotted lines), such as known in the art to allow triangulated range cloud measurements to be made using one, or both cameras. Tablet 621 is shown having just the stereo pair of cameras.

It is noted that the invention provides an easy to teach system to allow the therapist to develop and/or tailor exercises to specific patients in a manner in which the therapist is accustomed, and to monitor the patients progress, building a data base for future reference where desired. The data base can be relative to the specific patient and be included in their electronic medical records, and/or it can be incorporated into a larger data base of patient, injury or exercise types, for example.

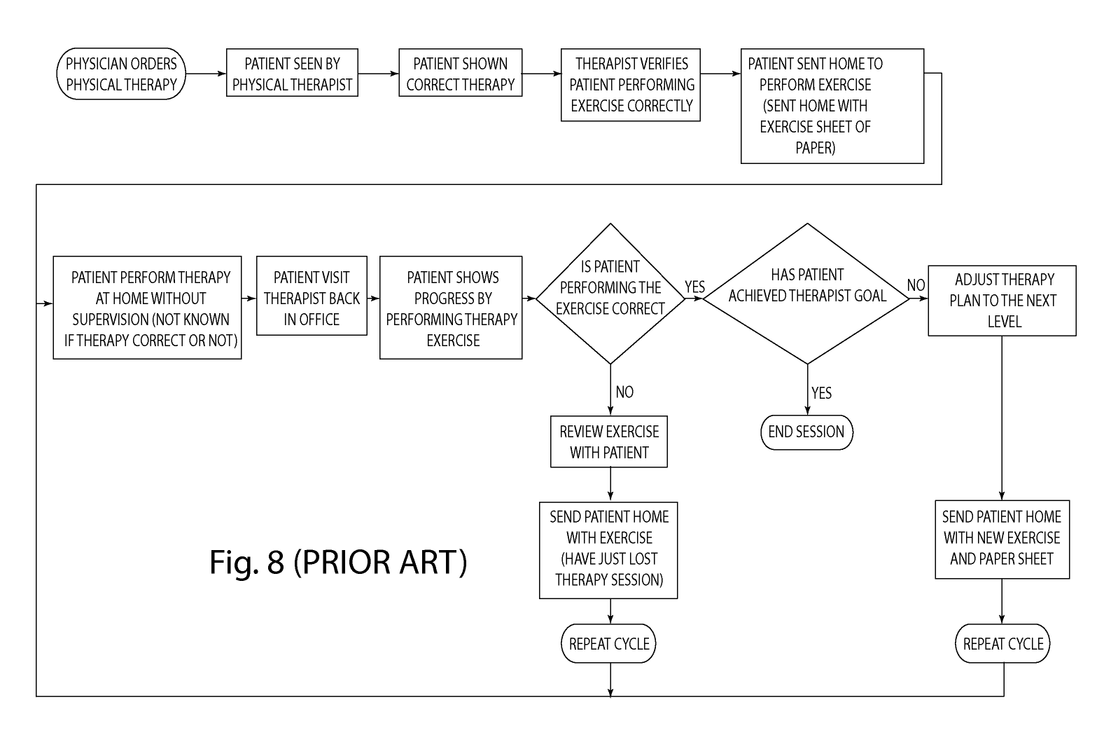

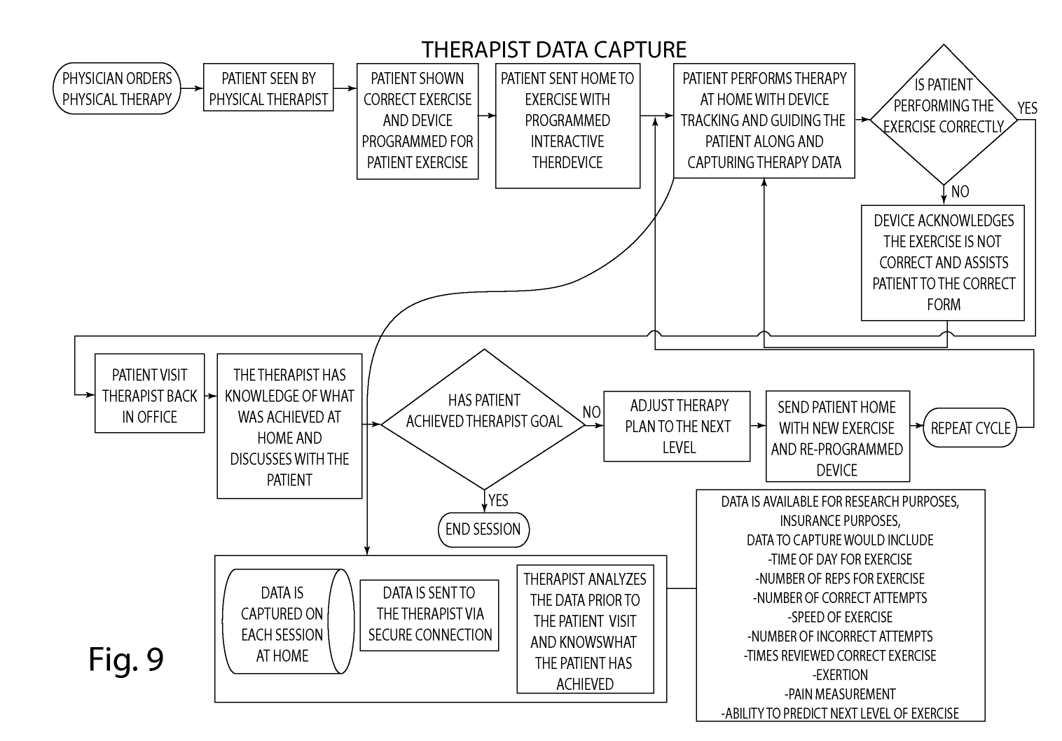

### FIGS. 7-9

FIG. 3 has illustrated an arm exercise employing an arm rest and calibration block set up. FIG. 7 illustrates an alternative (or possibly additional) approach teaching of the patient to position and orient their arm (or other body portion in other exercises) based on the therapy program determined.

As noted above, the camera such as 700 can be used to sense points on the person and using this data, various angles and other relationships calculated. These results can then be compared to norms desired, and/or to the initial taught values and instructions provided to the patient using voice, computer graphics or other methods. The camera which may be part of smartphone or tablet computer but is here mounted to a display 701 and controlled by a computer 702. Not shown for clarity is an LED illuminator such as 420 in FIG. 4 used to illuminate the targets from a point near the camera. Connecting wires or wireless connections of components are also not shown for clarity.

In this example the user puts on retroreflective elastic band targets such as 715, 716 and 717, which can for example be purchased from Reflex and are typically made for joggers and others.

Once the person sets the camera up and points it toward his arm, the camera can see the targets on the arm, which he or she has placed in the same locations on the arm as in the therapy clinic. From the spacing and location of these targets on say the fore arm, the angulations of the forearm can be determined, and whether or not it is resting on the table. If the camera horizontal axis is parallel to the table and a line between targets 716 and 717 is parallel to this axis then the arm is on the table in starting position (assuming the person is resting on the table, and not holding his arm in space above the table—which also can be determined if the camera is squarely mounted). This data can be used to audibly or graphically under control of the computer instruct the person to position their arm properly on the table. With the elbow resting on the table, the angulations in the plane of the table is determined from any foreshortening in the spacing S between targets 716 and 717, and if so, suitable instructions given to the patent to rotate the forearm with the wrist closer or farther away from the camera as the case may be. The direction of motion can be determined from observing in the computer whether S is increasing (becoming more parallel to the camera as desired) or decreasing.

Another variable to be considered therapeutically is the angulation of the arm between the elbow and shoulder, shown here as angle beta. In some cases beta is desirably 45 degrees, and should generally not be 90 degrees (vertical). Beta as well can be calculated from targets 715 and 716 relative to the table or the line formed by 716 and target 717 and instructions provided to the patient to move his elbow on the table so as to achieve this angle as taught by the therapist during the training session in the clinic (and possibly in some cases by a “virtual” therapist program in the computer).

In real time the various target locations and parameters may be calculated and instructions given such that within 10-20 seconds the person can be in a suitable position to begin exercise. If desired, a dry run can be made by the patient and the movements then compared to the taught program and further corrections made if necessary.

The invention herein provides a method for the accumulation of data from large numbers of patients over time and, using same, an improvement in therapy provision and teaching of therapists. The construction of a data base using the device allows a best practice norm to be created for a person, for a small group (say patients of a given clinic), or for a large group (such as all persons in a given country say with the same problem), or all persons with related problems, or whatever desired.

Note that as an alternative to the patient doing a set up at home, a fixed set up (say on a board, in the case of the arm) can be prepared at the clinic and taken home. This is feasible particularly for exercises not involving large movements, such as hand or foot therapy for example. While objectionable to some due to bulk, such a set up could be used to locate the camera relative to a fixed position such that alignment and setup steps could be eliminated. For example if the smartphone or tablet approach of FIG. 3 or FIG. 5 is used, this device could be plugged into a dock, whose position would be fixed relative to the part of the body to be exercised, such as the elbow in the arm example herein.

For some exercises, particularly but not necessarily those with larger movements, some steps for setting up a person in the home are as follows.

In step 1 the person holds the starting position taught in the therapy clinic, including an object if used.

In step 2 the camera then determines the location of a plurality of points, typically 3 or more, any or all of which can be determined from target points on the person, or other points determined by range or edge sensing.

In step 3 the computer solves, using the points found, in combination with knowledge of the exercise itself, for position and orientation data of the person with respect to the camera.

In step 4 the computer provides information based on this data to the patient to guide them into repositioning themselves in position, orientation or both, to better correspond to the situation in the clinic.

In step 5, alternatively or additionally to step 4, the computer corrects the readings taken based on the new position or orientation data, to more closely match those in the clinic.

In step 6 the person performs an exercise which is compared in the computer to the data taken from the same exercise in the clinic. If the data is sufficiently similar, a signal is given to the user to proceed with the exercise set. If however there is something wrong, suggestions are given to the user to change position, orientation or some other variable and retry. One other variable for example could be range of motion or rate of motion.

Some figures above have illustrated a version of the device utilizing a tablet computer having a camera. One such device is comprised by the well-known iPad by Apple Inc. The iPad (and other tablets as well) has the advantage that it allows the arm movement to be tracked with a RGB (color) or black and white webcam the same as described above, while also displaying the arm movement in a convenient manner to the patient. The iPad also has the ability to transmit the data as well as the video images to the therapist and the record them. A disadvantage however is that the typical iPad is fixed in terms of its camera design and the wavelengths to which it can see, and this limits the technology to can be employed to sense the arm.

Another thing about the iPad that has to be taken into account is that, like any mass produced consumer device, its field of view is fixed, at least today. As one tries to look at ever larger portions of the body, the screen needs to be further away and thus becomes more difficult to see and in particular becomes difficult or impossible to actually touch or otherwise interact with while one is doing the movements. Cameras such as 210 with different lenses, or zoom lenses are more versatile in this regard, and may alternatively be used if suitable connections to the iPad or other computer are made.

Many desirable exercises and their accessories (weights, resistance bands, targets and the like) can be designed to mitigate the field of view problem. In many cases even a smart phone or other small camera computer device can be used instead of the tablet, and communication with the device done by voice during exercise (obviating any need to touch it), with displays as needed transmitted to a HDTV in the patients room, for example via WiFi, Bluetooth or the like. This same arrangement can be used in the therapy clinic, and can be preferable where large ranges of motion are needed, implying a large field of view and a larger distance between camera and patient.

### FIG. 10

FIG. 10A illustrates a lying down shoulder exercise such as shown in FIG. 1 and monitored by the invention similar to the companion shoulder exercise of FIG. 4. The patient 1000 lies on a bed or other surface not shown. The patient as part of the exercise is to move weight 1005 vertically up to the dotted line position (or some lower position if the therapist calls for same) by rotating their arm.

The weight in this case is targeted with retro-reflective material 1006, noting that as before an alternative is to use a targeted wrist band. Other targets useful for monitoring this exercise are the arm target 1010 above the elbow and the shoulder target 1011. These targets are here shown as bands which are easy to put on and take off, but they can be other types of targets, for example those attached to clothing.

Like FIG. 4, the therapist could just establish a desired end point box for the user to reach with the weight target centroid or other target parameter. But in this example the therapist has chosen to program a vertical rectangular box 1020 as a visual indicia whose ends 1021 and 1022 define the range of motion the weight should move through, and having sides 1024 and 1025 which define the side-side region that the weight should stay within. The utility of the latter side to side aspect is often demonstrated, as when the patient becomes tired, or is improperly performing the exercise they often stray out of the box to the sides. In this case an audible sound via the loudspeaker shown in FIG. 4A or a displayed signal or both may for example be provided to signal the person to get back “inside the box,” so to speak.

In this example, a different definition of the range of motion is used, since the one end of the range 1022 is fixed by the bed or other rest position which can be assumed as the starting point of motion. In this case the patient is judged to have reached his goal when he gets within 85% or some other therapist defined target of the top 1021 of the bounding box, which represents the total range of motion desired. For motivation, encouraging sounds and graphics can be optionally provided as the patient nears the goal. It is noted that limit 1021 may be selected to be lower than shown in the drawing, when a heavier weight for example is used, or for any other reason.

One can in another example be done using two such boxes one within the other. The inner box could be yellow and comprise a caution or approach type limit while the outer larger box would be a red limit. The crossing of yellow or red may also be used for scoring of a game or provide a performance rating for the therapist. For example the number of times in 10 repetitions of the exercise that you went out of the yellow box would count 1 each, and out of the red outer box, would be 4 each. In this example, the person with the lowest score wins. And a super low score for example could win a prize, say for the low score within a week of exercises between clinic visits.

It should be noted that data taken with the invention, as well as any still or video images that may be recorded (generally requiring the patients permission), can be stored as part of the patients medical record. Then if the patient becomes injured again, as happens in many cases, the range of motion performance at various times and other data is known to aid in building a treatment plan. The camera or cameras of the device can for example be programmed to record at certain intervals (for example at the beginning of a repetition and at the end), once per day for a given period. Any pain indications which the patient indicated would likely be noted as well, which can be entered easily using voice recognition to pick up the persons voice. These are only examples, and any other programming plan desired can be executed.

FIG. 10B illustrates a motion sequence 1060 of vertical y axis data points in one taken as a function of time for a person performing the exercise of FIG. 10A. For clarity only two repetitions are shown. Note that the person is getting more tired at the end and the rate (slope) on the upward movement portion of the curve stretches out. A reference curve 1065 (dotted lines) for good exercises is also displayed or otherwise available to the patient or therapist for the motion undergone, such as may be developed during a therapy session in a clinic, or based on a data base for the patient or a group of patients with similar problems is also shown and can be compared to the data from the patient.

The primary mode of operation we feel will be for the therapist to designate the ranges of motion for a given exercise, generally but not necessarily doing so while teaching the patient the exercise. It is noted however, that the information could be automatically entered from a program. For example using data previously known for that person, or for a representative group of persons similar to the person.

The therapist may also later change the settings for the person, for example by downloading to the persons computing device new ranges or goal points or other information. This can also be done where processing is centrally as noted in FIG. 6.

The movements undergone in doing physical therapy prescribed exercises can also be used to play a game in order to motivate the patient. For example, as the patient in FIG. 5 moves bar 505, points can be given for moving it correctly in xyz, even over a certain path that could be displayed graphically on the computer display. The closer to the path, in a given time duration, the more points, for example. Prizes can even be given, such as dinners at a local restaurant, if certain scores are achieved.

The example of FIG. 4 in which bounding boxes are used, and displayed to the patient/player illustrates another way to construct a game. It is noted that the boxes may also be used by the therapist (or others) to create a game, which can be done in a myriad of ways. For example, if the player only got within an ending box 8 times out of 10 tries, they could get a score of 8, for example. If however on two of those they moved their shoulder out of its box, they would be docked 3 points say, for a final score of 5. In FIG. 10 a total region box is shown, which could be used in a game to penalize a person if anywhere in the motion of the exercise they were out of a planned path.

Several of the above figures illustrate cameras of various sorts connected to computers and displays. While generally desirable to have a large TV display, in many cases this is difficult due to confines within the home, or the fact that the person exercising in a room with such a display may not be able to conveniently look at the display while doing the exercise in question. There are several potential answers to this problem. For example, the person can view a second large display located where they can see it more easily. Also by example, the person can view a second smaller display such as that of a tablet computer located close to them, connected, optionally wirelessly, to the camera (which can use in some cases the computer within the tablet, rather than a separate computer). Further by example, the person can view an image using video goggles wirelessly driven from the computer. This solves the problem but is confusing to some. The person can also view a display provided by a small light weight “pico” or “pocket” projector used to project the information on a convenient surface such as a wall directly in front of them. For example in the example of FIG. 3, a small projector could be connected to the phone 300 and used to project the display to a wall on the right of the drawing oriented 90 degrees from the display 350 shown. This would allow the person moving their arm up and down to look straight ahead at the projected display rather than have to turn their head up to 90 degrees to the right as required in FIG. 3. Such a small projector can be incorporated with the computer, with the camera external and connected via wireless or wire. Indeed some smartphones have such an integral projector now.

Shown in FIG. 4A for illustration is the use of a sewn-on target square 448. This can be used to monitor shoulder movement in the FIG. 4 example, and/or may be used as a calibration square to determine camera range and angulation to the person facing the camera using photogrammetry also described in co-pending applications and as noted relative to the use of target 427 on the resistance band. The target can be clipped on, pinned on, or otherwise attached the clothing, and does not necessarily have to be sewn on. It should be noted that the targets used 425, 426 and even a wrist target 430 could all have been so attached, and could be part of the clothing as well.

Where a hybrid sensor such as FIG. 6 is used, the range points in the shoulder region covered by 448 can be used to solve for changes in range occurring with movement, generally theses are unwanted changes. The absolute range itself so determined can be used for setup purposes to position the camera system relative to the person, or to correct changes from initial settings such as those used in the clinic, or in a previous performance of the exercise

While the device has been described in connection with numerous embodiments, it is to be understood that the specific mechanisms and techniques that have been described are merely illustrative of the principles of the device, and numerous modifications may be made to the methods and apparatus described without departing from the spirit and scope of the device.

1. A method for providing physical therapy instruction comprising:
electro-optically observing a therapeutic movement performed by a patient as part of a physical therapy regimen; and
providing to the patient, using a display, visual indicia relating to a desired therapeutic movement, the visual indicia being based on the therapeutic movement performed by the patient.

2. The method according to claim 1 wherein the therapeutic movement is performed by the patient in a clinical setting.

3. The method according to claim 1 wherein the visual indicia includes a virtual border superimposed over a display of a portion of the patient performing the therapeutic movement.

4. The method according to claim 1 wherein the visual indicia includes a virtual box superimposed over a display of a portion of the patient performing the therapeutic movement.

5. The method according to claim 1 further including providing to the patient a video of a therapeutic movement previously performed by the patient.

6. The method according to claim 1 further including modifying, using a computer, the visual indicia as the patient progresses through the physical therapy regimen.

7. The method according to claim 6 wherein said modification is made remotely.

8. The method according to claim 1 further including determining, using a computer, compliance with the desired therapeutic movement.

9. The method according to claim 1 further including comparing, using a computer, the electro-optically observed therapeutic movement with one of a plurality of therapeutic movements stored in computer readable memory.

10. The method according to claim 1 further including aggregating, in computer readable memory, data pertaining to the therapeutic movements performed by the patient.

11. The method according to claim 10 wherein the data further relates to discomfort experienced by the patient.

12. The method according to claim 10 further including evaluating the performance of the patient based on the data stored in the computer readable memory.

13. A system for providing physical therapy instruction, comprising:
an electro-optical sensor having an output, the electro-optical sensor including a field of view encompassing at least a portion of a therapeutic movement performed by a patient; and
a computer operatively coupled to the electro-optical sensor output, wherein the computer is adapted to determine instructional information for the patient in conjunction with the therapeutic movement performed in the electro-optical sensor field of view.

14. The system of claim 13 further including a display, wherein the instructional information is viewable by the patient on a display.

15. The system of claim 14 wherein the electro-optical sensor, the computer and the display are self-contained within a handheld housing.

16. The system of claim 14 wherein the instructional information includes an instructional modification of the therapeutic movement performed by the patient.

17. The system of claim 14 wherein the instructional information includes a virtual boundary superimposed over a video of the therapeutic movement performed by the patient.

18. The system of claim 14 wherein the instructional information includes a video of a therapeutic movement previously performed by the patient in a supervised setting.

19. The system of claim 14 wherein the instructional information includes a corrected movement superimposed over the therapeutic movement performed by the patient.

20. The system of claim 13 wherein the computer is adapted to correlate the electro-optically observed therapeutic movement with one of a plurality of therapeutic movements stored in computer readable memory.

21. The system of claim 13 wherein the computer is adapted to determine movement of the patient in three-dimensions based on the output of the electro-optical sensor.

22. The system of claim 13 wherein the electro-optical sensor includes a digital camera.

23. The system of claim 14 wherein the display is a projected display.

24. The system of claim 14 wherein the display is wearable by the patient.

25. The system of claim 13 wherein the instructional information is transmitted aurally to the patient.

26. A method for providing physical therapy instruction comprising:
electro-optically sensing a therapeutic movement performed by a patient in a clinical environment using a computer vision system;
recording information concerning the therapeutic movement, the recorded information including instructions provided to the patient in the clinical environment; and
displaying to the patient instructional information relating to a subsequent therapeutic movement as part of a physical therapy regimen, the instructional information being based on the instructions provided to the patient in the clinical environment.

27. The method according to claim 26 wherein the instructional information is determined by a computer based on the electro-optically observed therapeutic movement.

28. The method according to claim 26 wherein the instructional information includes an instructional modification of the therapeutic movement performed by the patient.

29. The method according to claim 26 wherein the instructional information includes a virtual boundary displayed over a video of the therapeutic movement performed by the patient.

30. The method according to claim 26 further including displaying a video of the therapeutic movement performed by the patient in the clinical environment.

31. The method according to claim 26 wherein the instructional information includes a corrected movement superimposed over the therapeutic movement performed by the patient.

32. The method according to claim 26 further including correlating, using a computer, the subsequent therapeutic movement with one of a plurality of therapeutic movements stored in computer readable memory.

33. The method according to claim 32 wherein the instructional modification includes a virtual simulation of one of the plurality of stored therapeutic movements.

34. The method according to claim 26 further including modifying the instructional information as the patient progresses through the physical therapy regimen.

35. The method according to claim 26 further including aggregating, in computer readable memory, data pertaining to each of a plurality of therapeutic movements performed by the patient.

36. A method for establishing a physical therapy database comprising:
providing a computer vision system for use in a patient's home;
obtaining patient movement data using the computer vision system as part of a physical therapy regimen;
recording the movement data into a database stored in computer readable memory; and
analyzing, using a computer, the database to determine the efficacy of the physical therapy regimen.

37. The method according to claim 36 wherein the analyzing computer is remotely located from the computer vision system.

38. The method according to claim 36 wherein the database includes movement data pertaining to a plurality of patients each participating in the physical therapy regimen.

39. The method according to claim 36 further including comparing the movement data to subsequent movement data from the patient.
